(19) United States
(12) Patent Application Publication
(10) Pub. No.: US 2017/0316790 A1
(43) Pub. Date: Nov. 2, 2017

(54) Estimating Clean Speech Features Using Manifold Modeling

(71) Applicant: KnuEdge Incorporated, San Diego, CA (US)

(72) Inventor: Bengt Jonas Borgstrom, La Jolla, CA (US)

(21) Appl. No.: 15/140,081

(22) Filed: Apr. 27, 2016

(51) Int. Cl. G10L 21/0232; G10L 15/14; G10L 13/07; G10L 15/02; G10L 25/84; G10L 15/20

(52) U.S. Cl. CPC G10L 21/0232; G10L 25/84; G10L 15/20; G10L 13/07; G10L 15/02; G10L 15/142

(57) ABSTRACT

The technology described in this document can be embodied in a computer-implemented method that includes receiving, at one or more processing devices, a portion of an input signal representing noisy speech, and extracting, from the portion of the input signal, one or more frequency domain features of the noisy speech. The method also includes generating a set of projected features by projecting each of the one or more frequency domain features on a manifold that represents a model of frequency domain features for clean speech. The method further includes using the set of projected features for at least one of: a) generating synthesized speech that represents a noise-reduced version of the noisy speech, b) performing speaker recognition, or c) performing speech recognition.

### TECHNICAL FIELD

This document relates to signal processing techniques used, for example, in speech processing.

### BACKGROUND

Manifold models are used in various signal processing applications. For example, a manifold can be used for representing a number of points from a multi-dimensional observation space [symbol] ^{D} (where D is the dimension of the observation space) in a linear or non-linear subspace [symbol] ^{K}, where K is less than D.

### SUMMARY

In one aspect, this document features a computer-implemented method that includes receiving, at one or more processing devices, a portion of an input signal representing noisy speech, and extracting, from the portion of the input signal, one or more frequency domain features of the noisy speech. The method also includes generating a set of projected features by projecting each of the one or more frequency domain features on a manifold that represents a model of frequency domain features for clean speech. The method further includes using the set of projected features for at least one of: a) generating synthesized speech that represents a noise-reduced version of the noisy speech, b) performing speaker recognition, or c) performing speech recognition.

In another aspect, this document features a system including a feature extraction engine and a projections engine. The feature extraction engine includes one or more processors, and is configured to receive a portion of an input signal representing noisy speech, and extract, from the portion of the input signal, one or more frequency domain features of the noisy speech. The projection engine also includes one or more processors, and is configured to generate a set of projected features by projecting each of the one or more frequency domain features on a manifold that represents a model of frequency domain features for clean speech. The projection engine is also configured to provide the set of projected features for at least one of: a) generating synthesized speech that represents a noise-reduced version of the noisy speech, b) performing speaker recognition, or c) performing speech recognition.

In another aspect, this document features one or more machine-readable storage devices having encoded thereon computer readable instructions for causing one or more processors to perform various operations. The operations include receiving a portion of a noisy input signal, extracting, from the portion of the input signal, one or more frequency domain features, and generating a set of projected features by projecting each of the one or more frequency domain features on a manifold that represents a model of frequency domain features for a corresponding clean signal. The operations also include generating, based on the set of projected features, an output comprising a noise-reduced version of the noisy input signal.

Implementations of the above aspects may include one or more of the following features.

A first portion of the frequency domain features can represent sound generated at the glottis, and a second a portion of the frequency domain features can represent an impulse response of the vocal tract of a human speaker. The manifold can correspond to a combination of factor analysis models each representing a subspace of a feature space associated with the model of frequency domain features for clean speech. The manifold can be learned using a corpus of clean speech samples. Generating the synthesized speech can include obtaining, from a first set of projected features a first spectra representing a first portion of the noise-reduced version of the noisy speech, and obtaining, from a second set of projected features, a second spectra representing a second portion of the noise-reduced version of the noisy speech. A time domain waveform of the noise-reduced version of the noisy speech can be generated by combining the first and second spectra. The first and second set of projected features can be obtained by projecting corresponding sets of frequency domain features extracted from the input signal on to two separate portions of the manifold, respectively. Each of the two separate portions of the manifold can represent a locally linear subspace of a feature space associated with the model of frequency domain features for clean speech. The manifold can represent time derivatives of the one or more frequency domain features. One or more time derivatives of at least a subset of the frequency domain features can be computed, and concatenated to the one or more frequency domain features for generating the set of projected features. The frequency domain features of clean speech can be modeled using a Hidden Markov Model (HMM) wherein each state of the HMM is represented by at least one factor analysis model.

Various implementations described herein may provide one or more of the following advantages. Clean speech may be generated from distorted and/or noisy input speech using a manifold model that is generative, and does not require examples of noise/distortion during the training stage. The manifold, even though learned using a corpus of clean speech, may be used for generating clean speech from input signals obtained in the presence of various different types of noises.

### BRIEF DESCRIPTION OF THE DRAWINGS

The patent application file contains at least one drawing executed in color. Copies of this patent or patent application publication with color drawings will be provided by the Office upon request and payment of the necessary fee.

FIG. 1 is a block diagram of an example of a network-based speech processing system that can be used for implementing the technology described herein.

FIG. 2 is a flowchart showing an example of a process for generating a set of projected features that may be used in various applications including speech synthesis, speaker recognition, and speech recognition.

FIG. 3 shows plots illustrating a simplified example of manifold projection.

FIGS. 4A-4C show spectrogram plots illustrating the results of applying the techniques described herein in the presence of different types of noise.

FIG. 5 shows examples of a computing device and a mobile device.

### DETAILED DESCRIPTION

This document describes technology for generating features representing de-noised or noise-reduced signal such as speech. In some implementations, features extracted from noisy and/or distorted speech are projected on a manifold that represents clean speech. The projected features can then be used, for example, in synthesizing signals representing the de-noised or noise reduced speech. High-dimensional features derived from clean speech (e.g. short-time spectral envelopes) can be considered to exist on a manifold which is locally linear and low-dimensional. Features extracted from noisy and/or distorted speech can be projected on to such a manifold to generate features representing clean speech. Because the learned manifold is locally linear, various sources of distortion (e.g. additive noise, transducer response) may be orthogonal to the corresponding local subspaces. In such cases, features extracted from distorted or noisy speech can be enhanced (or “cleaned”) by projecting them onto the learned manifold. The projected features thus obtained can be used for various purposes such as clean speech synthesis, speaker recognition, and/or speech recognition. While the technology described herein is illustrated using speech signals as the primary examples, the technology may also be used for enhancing other types of signals. Examples of such signals include music signals, image signals, video signals, astronomical signals, or other signals for which clean versions of the signals are available for training corresponding manifolds.

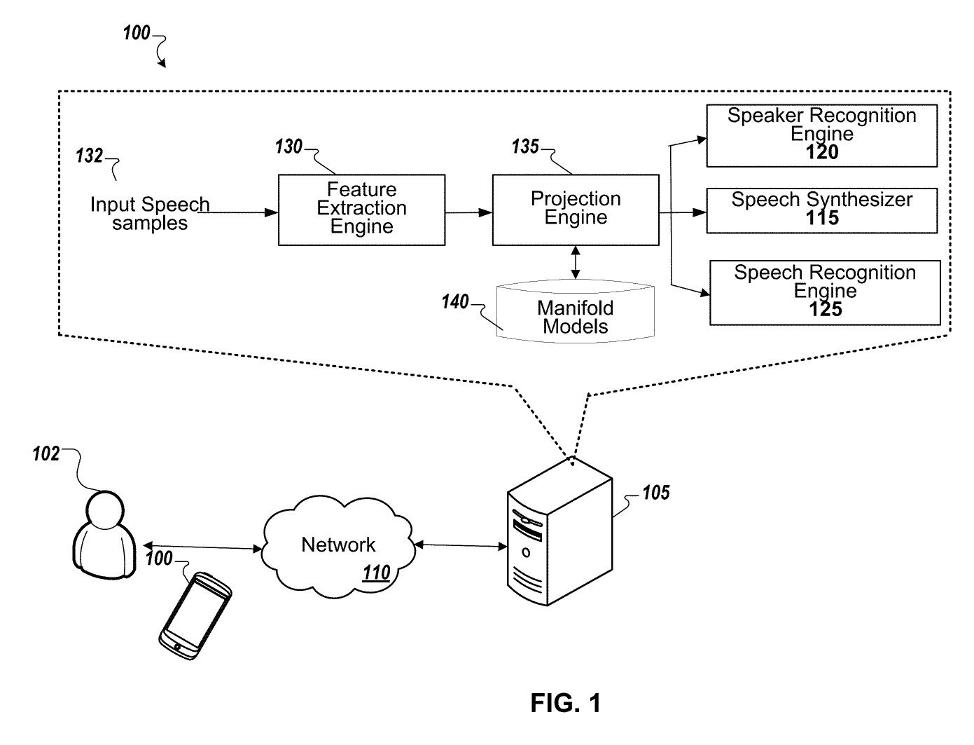

FIG. 1 is a block diagram of an example of a network-based speech processing system 100 that can be used for implementing the technology described herein. In some implementations, the system 100 can include a server 105 that executes one or more speech processing operations for a remote computing device such as a mobile device 107. For example, the mobile device 107 can be configured to capture the speech of a user 102, and transmit signals representing the captured speech over a network 110 to the server 105. The server 105 can be configured to process the signals received from the mobile device 107 to generate various types of information. For example, the server 105 can include a speech synthesizer 115 which can be configured to generate audio signals representing de-noised or noise reduced speech. In some implementations, the server 105 includes a speaker recognition engine 120 that can be configured to perform speaker recognition, and/or a speech recognition engine 125 that can be configured to perform speech recognition.

In some implementations, the server 105 can be a part of a distributed computing system (e.g., a cloud-based system) that provides speech processing operations as a service. For example, the server may process the signals received from the mobile device 107, and the outputs generated by the server 105 can be transmitted (e.g., over the network 110) back to the mobile device 107. In some cases, this may allow outputs of computationally intensive operations to be made available on resource-constrained devices such as the mobile device 107. For example, de-noised speech synthesis, speaker recognition, and/or speech recognition can be implemented via a cooperative process between the mobile device 107 and the server 105, where most of the processing burden is outsourced to the server 105 but the output (e.g., de-noised speech) is rendered on the mobile device 107. While FIG. 1 shows a single server 105, the distributed computing system may include multiple servers. In some implementations, the technology described herein may also be implemented on a stand-alone computing device such as a laptop or desktop computer, or a mobile device such as a smartphone, tablet computer, or gaming device.

In some implementations, the server 105 includes a feature extraction engine 130 for extracting one or more frequency domain features from input speech samples 132. In some implementations, the input speech samples 132 may be generated, for example, from the signals received from the mobile device 107. In some implementations, the input speech samples may be generated by the mobile device and provided to the server 105 over the network 110. In some implementations, the feature extraction engine 130 can be configured to process the input speech samples 132 to extract features such as discrete Fourier transform (DFT) or linear prediction (LP) coefficients. In some implementations, under an assumption that speech sounds occupy a confined region of the overall acoustic space, features representing speech data may be modeled as lying on or near a manifold embedded in the high dimensional acoustic space. In some implementations, where the speech data includes discriminative information separable from potentially confusable information, the extracted information may be further processed, for example, in accordance with a perceptually motivated model, to obtain a smaller number of features such as Mel-frequency cepstral coefficients (MFCC) or perceptual linear prediction (PLP) parameters. In some implementations, the feature extraction engine 130 can be configured to obtain DFT coefficients from the input speech samples 132 using, for example, a 512 point FFT, which can then be decomposed in the cepstral domain to extract a smaller number (e.g., 10-15) of features.

In some implementations, the feature extraction engine 130 may extract multiple feature vectors from the input speech samples 132. The extracted feature vectors may include, for example, mel-frequency coefficients, perceptual linear prediction features, or other features that may be used in speech synthesis, speaker recognition, speech recognition, or another speech processing application. In some implementations, the stream of input speech samples may be divided into multiple segments, and one or more feature vectors may be generated for individual segments. For example, the feature extraction engine 130 may create a sequence of feature vectors for samples representing every 10 milliseconds of the audio signal. Such short durations may be chosen, for example, because speech (which is typically a non-stationary signal) may be approximated as stationary within such short durations. Accordingly, feature extraction for speech applications can be performed based on short-time spectral analysis. While such features may have a high dimensionality, a majority of the inter-data correlation may approximately lie on a locally low-dimensional manifold.

In some implementations, speech may be represented as the convolution of two substantially independent signals: a source signal generated at the glottis, and the impulse response of the vocal tract which applies spectral shaping. In some implementations, these two signals may be decomposed by the feature extraction engine 130 in the cepstral domain, to generate separate sets of features for the source component and the vocal tract shaping component. The two sets of features may be referred to as the “source features” and “filter features,” respectively. The features extracted from a segment of speech signal at the n^{th} time index may therefore be represented as:

tₙ≈tₙ^{v}+tₙ^{s} (1)

where tₙ^{s} denotes the features for the source component, and tₙ^{v} denote the features for the vocal tract shaping component.

In some implementations, where the two components on the right hand side of equation (1) are substantially independent, the components may be modeled separately, for example, to reduce the complexity of the resulting manifolds. Other decompositions of the speech features tₙ may also be possible. In some implementations, speech signal may be resynthesized from the component sets of features (e.g., tₙ^{s} and tₙ^{v}), for example, by obtaining an estimate of tₙ using (1), and then obtaining short-time spectra using an inverse of the feature extraction process. The series of short-time spectra may be combined, for example, using an overlap-and-add or overlap-and-save process, to generate a time waveform representing the reconstructed speech signal.

In some implementations, the input speech samples 132 may represent noisy or distorted input speech signal, and the system 100 can be used to produce an enhanced (also referred to as de-noised, noise-reduced, or distortion-reduced) version of such input speech signal. In some implementations, this may be done by processing at least a portion of the features extracted from the input speech samples by the feature extraction engine 130. For example, if the speech features may be decomposed using equation (1), enhancing the set of features tₙ^{s} and tₙ^{v} separately prior to a re-synthesis process (e.g., as performed by a speech synthesizer 115) may result in an enhanced version of the input speech signal.

In some implementations, enhancing of the extracted features may be performed, at least in part, by a projection engine 135. The projection engine 135 can be configured to receive at least a portion of the features (e.g., one or more spectral features representing the input speech samples) extracted by the feature extraction engine 130, and generate a set of projected features by projecting each of the received features on a manifold that represents clean speech. One or more manifold models representing clean speech may be stored in a database 140 accessible to the projection engine 135. For example, the database 140 may store separate manifolds representing the source features and filter features, respectively, of clean speech. In some implementations, the database 140 may store multiple manifolds corresponding to different training data sets. For example, the database 140 may store manifolds corresponding to different genders, ethnicities, age ranges, languages, locations, or other parameters for which training corpuses may be available.

The manifold models stored in the database 140 can be learned using training data to capture the behavior of features for clean speech. If a feature is then extracted from some distorted speech signal, the extracted feature may be interpreted as the superposition of an underlying clean component and a residual noise component. In some implementations, if the dimension of the local subspaces in the manifold is low, a significant portion of the noise energy can be expected to lie orthogonal to these subspaces. In such cases, the extracted features may be enhanced, for example, by computing projections of the extracted features onto one or more learned manifolds. In some implementations, such projection onto a manifold representing clean speech may attenuate at least a portion of the additive noise, thereby producing a noise-reduced or enhanced version of the corresponding features, which may then be used for various purposes such as speech synthesis, speaker recognition, and/or speech recognition.

The manifolds stored in the database 140 may be learned in various ways. In some implementations, a manifold can be learned as a mixture of models that may be globally non-linear but locally linear. The models used in the mixture can include probabilistic models such as factor analysis models or probabilistic principal component analysis (PCA) models. The manifolds can be learned, for example, via an unsupervised learning process on a corpus of clean speech data. In some implementations, the training corpus can include clean speech data from multiple speakers having varying characteristics. For example, the training corpus can include clean speech data obtained from speakers of different ethnicities, accents, tonal qualities, genders, races etc. In some implementations, different manifolds specific to one or more characteristics (e.g., gender, age, ethnicity, or a combination of characteristics) may be trained if an appropriate training corpus is available.

In some implementations, the use of mixture models allows for the construction of a high-dimensional nonlinear manifold from low-dimensional linear probability distributions. Each mixture may be defined by a probability density function (pdf) with a low-dimensional subspace, using, for example, a factor analysis model. The combination of such mixtures may enable the modeling of the nonlinearities inherent in complex signals such as speech features.

Factor analysis (FA) is a statistical method for modeling the covariance structure of high dimensional data using a smaller number of latent variables. In some implementations, factor analysis can provide a generative model where the inter-data correlation lies within a low-dimensional subspace. An FA model can be represented as:

t=Wx+μ+ε

Wε [symbol] ^{D×K} (2)

where

tε [symbol] ^{D}, με [symbol] ^{D}, and xε [symbol] ^{K}

are the data, mean, and latent vectors, respectively, and

D [symbol] K.

Further, ε is a noise term, and W is the factor loading matrix that defines the subspace within which the inter-data correlation lies. The latent vector may follow a standard normal distribution, such that:

p(x)= [symbol] (x;0,I) (3)

The noise term may also follow a normal distribution with isotropic covariance, such that:

p(ε)= [symbol] (x;0,σ²I) (4)

In some implementations, the proposed framework can be generalized to include a noise model with a diagonal covariance matrix with positive diagonal elements. For the isotropic covariance case shown in equation (4), the marginal distribution of the data vector is given by:

p(t)= [symbol] (t;μ,σ²I+WW^{T}) (5)

Under the framework described above, the posterior distribution of the latent factor conditioned on an observed data vector is given by:

p(x|t)= [symbol] (x|M⁻¹W^{T}(t−μ),σ⁻²M) (6)

where

M=(σ²I+W^{T}W) (7)

and the model parameters μ, σ², and W may be estimated from training data using, for example, expectation-maximization (EM) or maximum likelihood (ML) criteria (in the case of isotropic noise).

If a data vector is projected on the latent space, the orthogonal projection may be represented as:

\hat{x}=(W^{T}W)⁻¹W^{T}(t−μ) (8)

In some implementations, this may also be computed as the expected value of the posterior distribution as:

\hat{x}=M⁻¹W^{T}(t−μ) (9)

As evidenced from equations (8) and (9), the projected components do not include the noise component ε. In particular, as σ² increases, the estimated latent vector may approach zero, thereby filtering out the components oft that are not attributable to the latent vector. Using the projection from (9), a reconstruction of the data vector can be obtained as:

\hat{t}=WM⁻¹W^{T}(t−μ)+μ (10)

Therefore, such a reconstruction may be interpreted as only containing variability associated with inter-data correlation, with the components associated with E removed. Such a factor analysis process can therefore be used in a de-noising or noise reduction process, as described herein.

Because a factor analysis model confines the inter-data correlation to lie within a low dimensional subspace, a mixture of factor analyzers may be used in approximating a globally non-linear manifold as a combination of locally linear subspaces. In such a mixture of factor analyzers (mFA) model, the data vector can be generated by one of M mixtures, each of which includes an individual factor analysis model. Such a data vector can be given by:

t=Wₘxₘ+μₘ+εₘ (11)

Conditioned on the mixture membership, the distribution of the data vector, which may be considered equivalent to that in (5), is given by:

p(t|m)= [symbol] (t;μₘσₘ²I+WₘWₘ^{T}) (12)

By marginalizing over mixture memberships, the marginal distribution of the data vector becomes:

p(t)=Σₘ₌₁^{M}p(t|m) (13)

In some implementations, for an mFA manifold model, EM may be used to simultaneously train the model parameters for all mixtures, along with mixture priors.

Once a manifold model is learned or trained, the model may be stored in the database 140, and accessed by the projection engine 135 for computing projections of the features extracted from the input speech samples 132. For example, the projection engine 135 can be configured to project a data vector of extracted features onto a manifold defined by an mFA model. This may be done, for example, by first projecting the data vector onto the latent space, followed by reconstruction into the full space. Such a reconstruction can be expressed as:

$$\begin{matrix}\hat{t} = {\sum }_{m = 1}^{M} P ( m \vert t ) {\hat{t}}_{m} \\ = {\sum }_{m = 1}^{M} P ( m \vert t ) ( {W}_{m} {M}_{m}^{- 1} {W}_{m}^{T} ( t - {μ}_{m} ) + {μ}_{m} )\end{matrix} \qquad ( 14 )$$

where P(m|t) is the posterior probability that t was generated by mixture m, and is given by:

$$P ( m \vert t ) = \frac{{π}_{m} p ( t \vert m )}{{\sum }_{j = 1}^{M} {π}_{j} p ( t \vert j ) } \qquad ( 15 )$$

In some implementations, the projection may also be computed as a “hard decision” as:

$$\begin{matrix}\hat{t} = {W}_{{m}_{*}} {M}_{{m}_{*}}^{- 1} {W}_{{m}_{*}}^{T} ( t - {μ}_{{m}_{*}} ) + {μ}_{{m}_{*}} \\ where & ( 16 ) \\ {m}_{*} = {arg max }_{m} P ( m \vert t ) . & ( 17 )\end{matrix}$$

The data vectors in the above examples are assumed to be independent with respect to time. In some implementations, the data vectors may exhibit temporal correlation, which may be leveraged, for example, to increase the accuracy of a manifold model. In some implementations, the temporal correlation may be modeled by including dynamic information in the design of the data vector. For example, for each static data vector (both in the training phase, as well as during runtime), the estimated velocity (e.g., first order derivatives) and acceleration vectors (e.g., second order derivatives) can be computed, and concatenated to produce a higher dimensional vector that accounts for the dynamic information. In some implementations, a Hidden Markov Model (HMM) based process may be used to generate manifolds that model the temporal evolution of data. In such HMM based models, each hidden state may use a factor analyzer to define the observation distribution. For example, if the HMM-FA model includes of M discrete hidden states, the distribution of data vectors, conditioned on state membership, is given by:

p(tₙ|sₘ)= [symbol] (tₙ;μₘσₘ²I+WₘWₘ^{T}) (18)

where sₘ denotes the m^{th} state, and subscripts on the data vectors denote time index. The posterior probabilities of state occupation can be estimated recursively, for example using the Forward Algorithm, to decode the HMM-FA as:

$$P ( {s}_{m} \vert {t}_{n} , … , {t}_{1} ) = \frac{p ( {t}_{n} \vert {s}_{m} ) {\sum }_{j = 1}^{M} {a}_{jm} P ( {s}_{j} \vert {t}_{n - 1} , … , {t}_{1} )}{{\sum }_{k = 1}^{M} p ( {t}_{n} \vert {s}_{k} ) {\sum }_{j = 1}^{M} {a}_{jk} P ( {s}_{j} \vert {t}_{n - 1} , … , {t}_{1} )} \qquad ( 19 )$$

where, aᵢⱼ is the probability of transitioning from state i to state j in one time index, and can be estimated based on training data. In some implementations, the HMM-FA model can be generalized such that each hidden state uses an mFA (rather than a single FA) to define the observation distribution. For a single FA HMM, the projected data vector is given by:

\hat{t}ₙ=Σₘ₌₁^{M}P(sₘ|tₙ, . . . ,t₁)×(WₘMₘ⁻¹Wₘ^{T}(tₙ−μₘ)+μₘ) (20)

In some implementations, the HMM-FA model may be decoded as a “hard decision” using a Viterbi process as:

$$\begin{matrix}P ( {s}_{m} \vert {t}_{n} , … , {t}_{1} ) = \{ \begin{matrix}1 , & if m = {m}_{*} \\ 0 , & else\end{matrix} \\ where & ( 21 ) \\ {m}_{*} = {arg max }_{m} p ( {t}_{n} \vert {s}_{m} ) {\sum }_{j = 1}^{M} {a}_{jm} P ( {s}_{j} \vert {t}_{n - 1} , … , {t}_{1} ) & ( 22 )\end{matrix}$$

In such cases, the projection can be computed as:

\hat{t}ₙ=P(sₘ|tₙ, . . . ,t₁)×(WₘMₘ_{ₓ}⁻¹Wₘ_{ₓ}^{T}(tₙ−μₘ)+μₘ) (23)

The set of projected features generated by the projection engine 135 may be used for various purposes. In some implementations, the projected features are provided to a speech synthesizer 115 for generating signals indicative of a cleaned or enhanced version of the noisy or distorted input speech. The signal generated by the speech synthesizer 115 may then be provided to an acoustic transducer (e.g., over the network 110) that generates an acoustic output based on the signal. For example, the signal generated by the speech synthesizer may be provided to the mobile device 107 such that an acoustic output corresponding to the cleaned speech is generated through a speaker of the mobile device. The projected features generated by the projection engine 135 may also be used for other applications. For example, the projected features may be generated during pre-processing an input signal for a speech recognition engine 125 that performs automatic speech recognition (ASR). The projected features may also be generated during pre-processing an input signal for a speaker recognition engine 120.

In some implementations, the technology described herein may improve the perceptual quality of speech (e.g., for human listening) subjectively and/or objectively. Because this may be done using only a corpus of clean speech, and relying on generative models, the technology descried herein may facilitate an easier training process that does not require examples of various types of noise. However, if a corpus of noisy speech is available, discriminative training can be applied to generate additional manifolds that may further improve the de-noising process described herein. For example, if a corpus of “stereo” noisy speech (including speech signals with artificial noise added, along with the corresponding clean reference signals) is available, the local FA models can be trained to discriminate between speech and noise components. In such cases, the generated manifold models may attenuate noise components even more effectively during the enhancement process. In some implementations, the parameters of a generative model are trained using the ML criteria. For a discriminative model, the cost function that is optimized may take into account both clean and noisy versions of signals. For example, a cost function which minimizes the mean squared error (MSE) between features from clean data, and corresponding post-enhancement features from noisy versions of the data may be used. In some implementations, a perceptually relevant cost function may be also be used.

In some implementations, the technology described herein may also be used in conjunction with other noise suppression processes. For example, the technology described herein may be used in series with a spectral subtraction process used for attenuating stationary noise. A spectral subtraction process can be used, for example, to estimate a noise floor and enhance the overall spectra by subtracting the estimate of the noise floor from the overall spectra. While spectral subtraction may improve the overall signal to noise ratio (SNR), in some cases, the process may introduce undesired (and perceptually annoying) artifacts such as “musical noise.” In some cases, the technology described herein may be used to attenuate such artifacts, because the artifacts generally do not resemble clean speech. Therefore, the technology described herein may also be used to improve de-noising techniques such as spectral subtraction.

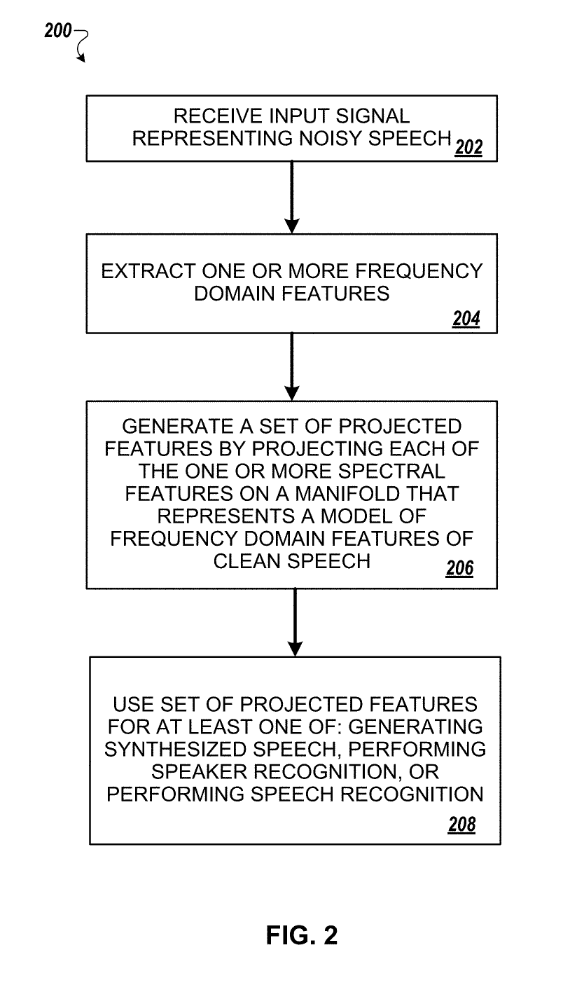

FIG. 2 is a flowchart illustrating an example implementation of a process 200 for generating enhanced features representing de-noised or noise-reduced version of noisy input speech. In some implementations, at least a portion of the process 200 is performed at one or more components of a computing device such as the server 105. For example, portions of the process 200 may be performed at the feature extraction engine 130 and/or the projection engine 135 of the server 105. Operations of the process 200 includes receiving at least a portion of an input signal representing noisy speech (202). This can include receiving samples of input speech at a feature extraction engine. The samples can correspond to portions of the input speech signal.

Operations of the process 200 also includes extracting one or more frequency domain features of the noisy speech from portions of the input signal (204). This can be done, for example, by the feature extraction engine 130 described above with reference to FIG. 1. Extracting the one or more frequency domain features can include, for example, computing a transform (e.g., DFT) on portions of the input signal, and computing cepstral coefficients from the DFT coefficients. This can be done, for example, by computing an Inverse Fourier Transform (IFT) on the logarithm of the DFT coefficients. In some implementations, a portion of the frequency domain features represents sound generated at the glottis. Such features may be referred to as “source features.” A portion of the frequency domain features may also represent an impulse response of the vocal tract, representing how the sound generated by the glottis is spectrally shaped by the vocal tract. Such features may be referred to as “filter features.”

Operations of the process 200 further include generating a set of projected features by projecting each of the one or more spectral features on a manifold that represents a model of frequency domain features for clean speech (206). This can be performed, for example, by the projection engine 135 described above with reference to FIG. 1. In some implementations, the manifold can correspond to a combination of factor analysis models each representing a subspace of a feature space associated with the model of frequency domain features for clean speech. In such cases, each of two separate portions of the manifold may represent a locally linear subspace of a feature space associated with the model of frequency domain features for clean speech. Such a manifold can be learned, for example, using equations (11) to (13) on a corpus of clean speech samples. In some implementations, in addition to the frequency domain features of clean speech, the manifold also represents time derivatives (e.g., first, second, or higher order derivatives) of the one or more frequency domain features. Such manifolds can be used, for example, to model dynamic features of speech. Data vectors for such manifolds can be generated, for example, by computing one or more time derivatives of at least a subset of the frequency domain features, and concatenating the time derivatives to the one or more frequency domain features. In some implementations, the dynamic features of speech may also be modeled using HMMs. In some implementations, each state of the HMM can be represented by at least one factor analysis model.

Operations of the process 200 also includes using the set of projected features for generating synthesized speech that represents a noise-reduced version of the noisy speech, performing speaker recognition, or performing speech recognition (208). This can be performed, for example, by one of the speech synthesizer 115, speaker recognition engine 120, or speech recognition engine 125 described above with reference to FIG. 1. In some implementations, generating the synthesized speech can include obtaining a first spectra and a second spectra from a first set and a second set, respectively, of projected features. The first and second set of projected features can be obtained, for example, by projecting corresponding sets of frequency domain features extracted from the input signal on to two separate portions of the manifold, respectively. Each of the first and second spectra may represent respective portions of a spectra of the noise-reduced version of the noisy speech. In some implementations, synthesized speech can be generated by combining the first and second spectra (e.g., using an overlap-add or overlap-save process) to produce a time domain waveform of the noise-reduced version of the noisy speech. Representation of such a time domain waveform may then be provided to an acoustic transducer (e.g., a speaker) for the transducer to generate an acoustic output.

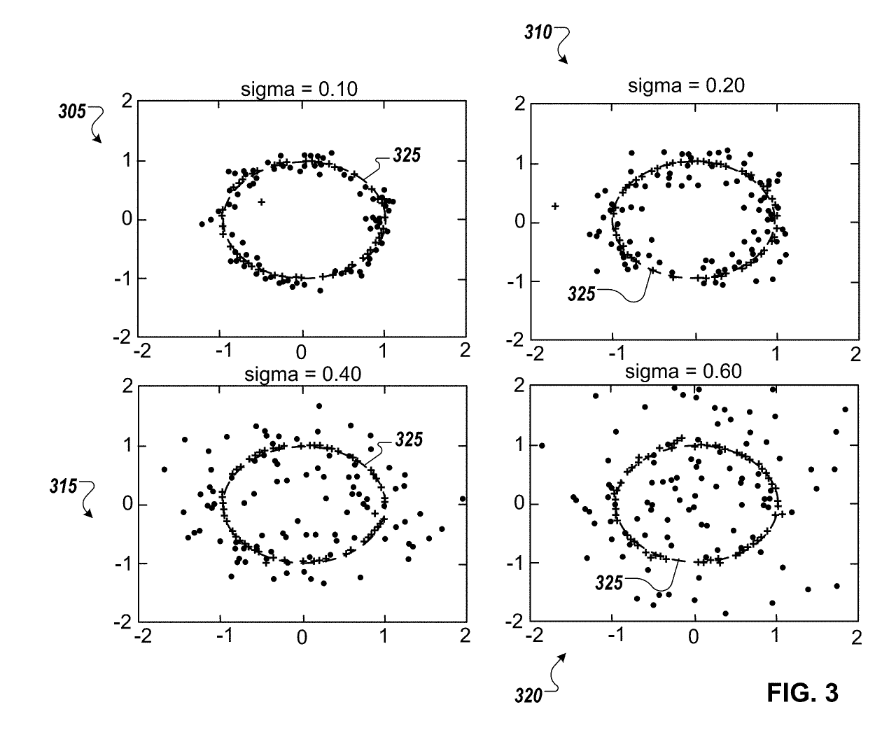

Due to the typically high dimensionality of speech features, providing a visual representation of corresponding manifolds is challenging. FIG. 3 shows plots illustrating simplified examples of projecting noisy samples onto a learned manifold. For this example, a 10-mixture mFA model was trained on 10K samples randomly drawn from the unit circle. The noisy observations were simulated by randomly sampling from the unit circle and adding isotropic noise with a given variance σ². The four panels 305, 310, 315, and 320 show the results of manifold projection for various values of σ². In each panel, the dots represent the observed noisy samples, and the crosses denote the resulting reconstructions using equation (14). The unit circle 325 is plotted as a dashed line for reference. Because the reconstructions were approximately all on the unit circle, the mFA enhancement technique was able to effectively project the noisy data vectors onto the original manifold, thereby filtering out the additive noise to a significant extent. In addition, the projections were not significantly affected by the variance of the noise.

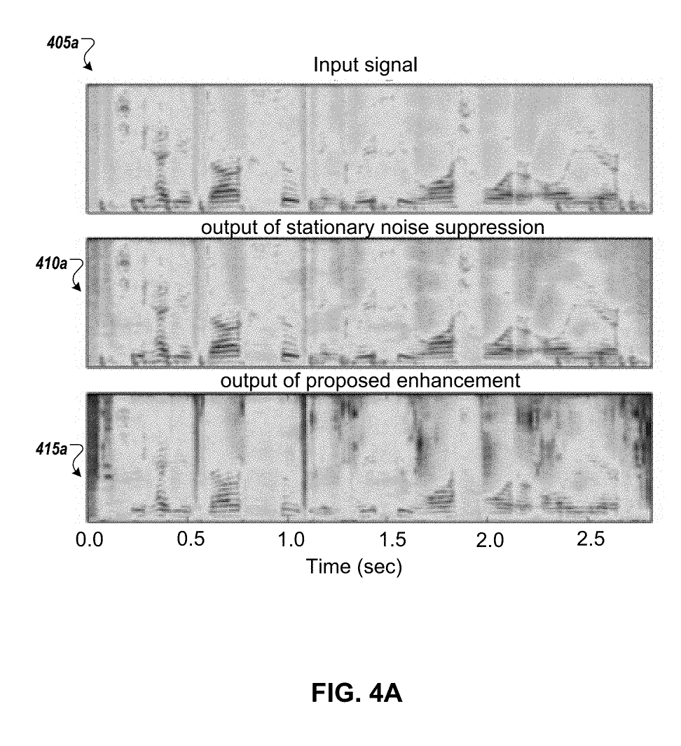

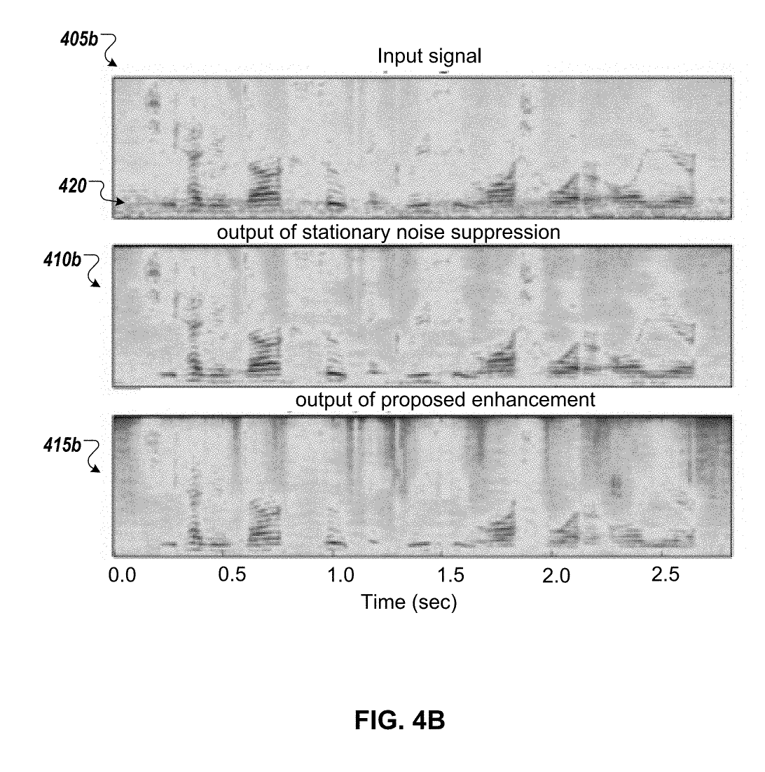

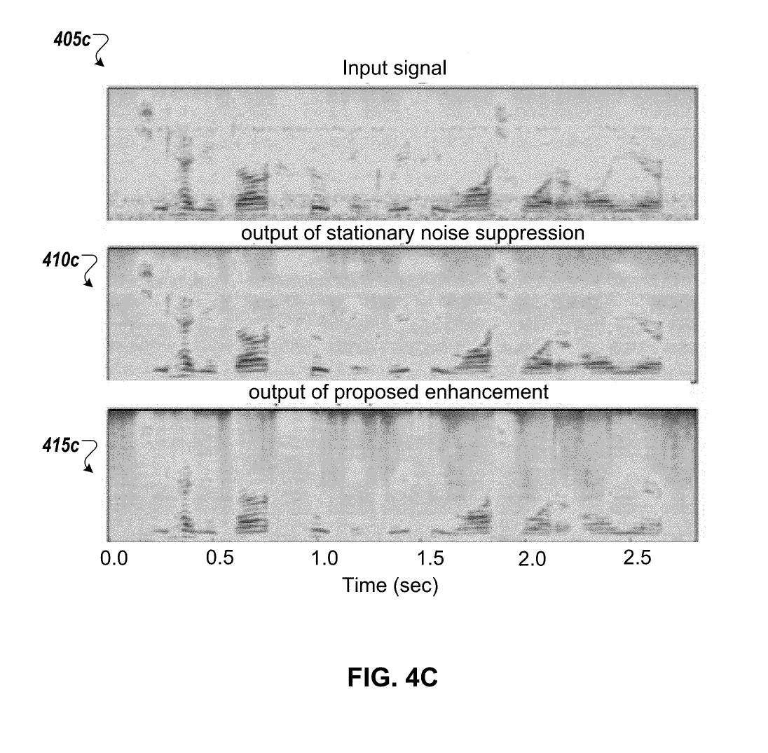

FIGS. 4A-4C show spectrogram plots illustrating the results of applying the techniques described herein in the presence of different types of noise. Specifically, the spectrograms in FIGS. 4A-4C represent examples where the enhancement techniques described herein were applied to vocal tract shaping features (or filter features) tₙ^{v}, when used in series with a stationary noise suppression system. In FIGS. 4A-4C, the top panels (405a, 405b, or 405c, respectively) show the spectrograms of the observed noisy signals, the middle panels (410a, 410b, and 410c, respectively) show the spectrograms of the outputs of the stationary noise suppression system, and the bottom panels (415a, 415b, and 415c, respectively) show the spectrograms of the outputs of an enhancement system employing the manifold based techniques described herein. In these examples, the manifold for tₙ^{v} was trained as a 256-mixture mFA model, with D=20, and K=2.

FIGS. 4A-4C each represents the results for a different type of noise. Specifically, in FIG. 4A, the input signal included gunshot noise (at 10 dB SNR) during the intervals 0.0-0.5 sec, 1.1-1.5 sec, and 2.3-2.6 sec. As shown in the spectrogram 405a, the noise is characterized by rapidly appearing low frequency energy. As illustrated by the spectrogram 410c, the stationary noise suppression system was not able to suppress such non-stationary noise. However, the manifold projection based enhancement significantly attenuated the noise (as illustrated in the spectrogram 415a by the low energy distribution in the corresponding intervals).

FIG. 4B shows the results of the manifold based enhancement for Babble noise at 10 dB SNR. As shown in the spectrogram 410b, the stationary noise suppression system attenuated the long-term noise floor 420 significantly, but at the cost of introducing musical noise. These artifacts are characterized by rapidly appearing narrowband signal components, for example, in the mid frequencies during the intervals 0.0-0.2 sec, 0.8-1.0 sec, and 1.8-2.0 sec. As shown in the spectrogram 415b, the manifold based enhancement was able to significantly reduce these artifacts because they exhibit behavior which is different from clean speech.

FIG. 4C shows the results of the manifold based enhancement for stationary low frequency noise (F16 noise) at 10 dB SNR. As shown in the spectrogram 410c, the stationary noise suppression system attenuated the stationary low frequency noise, but left residual noise due to the tone in the higher frequencies. As shown in the spectrogram 415c, the manifold based enhancement was able to suppress the residual tone, as well as filter out some musical artifacts.

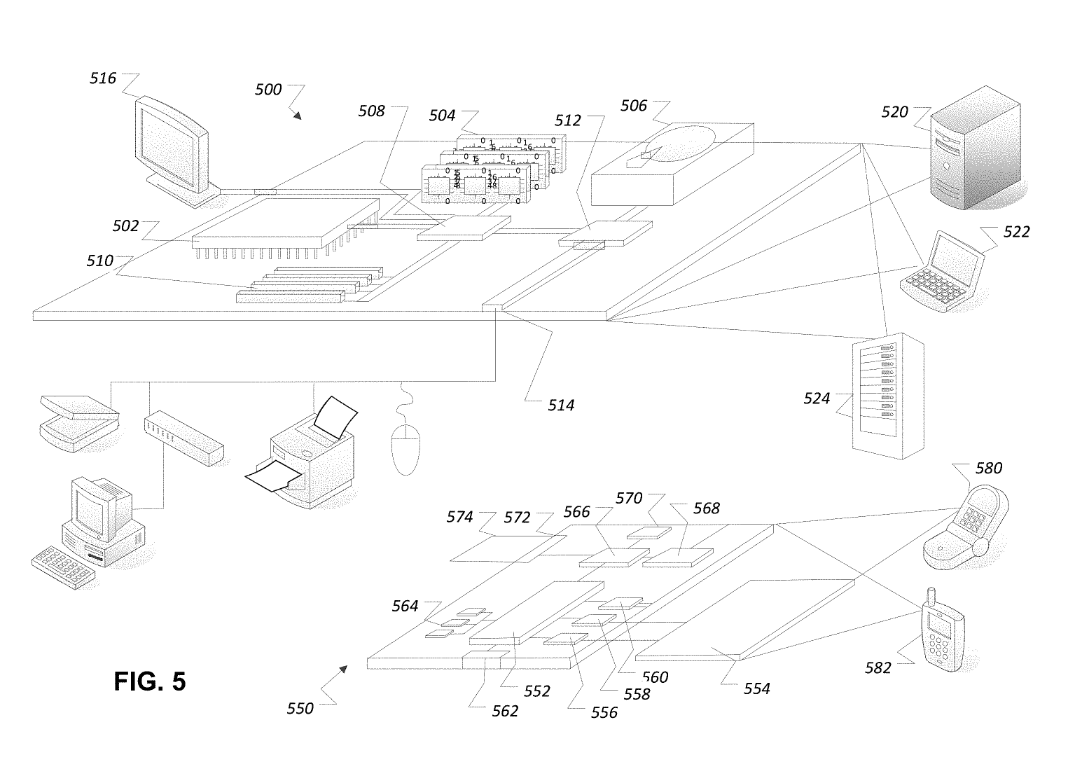

FIG. 5 shows an example of a computing device 500 and a mobile device 550, which may be used with the techniques described here. For example, referring to FIG. 1, the feature extraction engine 130, projection engine 135, speech synthesizer 115, speaker recognition engine 120, speech recognition engine 125, or the server 105 could be examples of the computing device 500. The device 100 could be an example of the mobile device 550. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, tablet computers, e-readers, and other similar portable computing devices. The components shown here, their connections and relationships, and their functions, are meant to be examples only, and are not meant to limit implementations of the techniques described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, memory on processor 502, or a propagated signal.

The high speed controller 508 manages bandwidth-intensive operations for the computing device 500, while the low speed controller 512 manages lower bandwidth-intensive operations. Such allocation of functions is an example only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device, such as the device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, memory on processor 552, or a propagated signal that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through an acoustic transducer or speaker, e.g., in a handset of device 550. Such sound may include sound from voice telephone calls, may include recorded sound (e.g., voice messages, music files, and so forth) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, tablet computer, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well. For example, feedback provided to the user can be any form of sensory feedback (e.g., visual feedback, auditory feedback, or tactile feedback). Input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can be implemented in combination in a single implementation. Conversely, various features that are described in the context of a single implementation can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. For example, while the above description primarily uses an example where the speech features are decomposed into source features and filter features, other decomposition schemes are also possible without deviating from the scope of the technology. In some implementations, the features may not be decomposed at all, and a single manifold may be trained and used for all speech data. In some implementations, the technology can be made speaker-dependent by adapting the mixture model for different speakers. This may, in some cases, improve results for those particular speakers, thereby providing advantages in some applications.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

As such, other implementations are within the scope of the following claims.

What is claimed is:

1. A computer-implemented method comprising:
receiving, at one or more processing devices, a portion of an input signal representing noisy speech;
extracting, from the portion of the input signal, one or more frequency domain features of the noisy speech;
generating a set of projected features by projecting each of the one or more frequency domain features on a manifold that represents a model of frequency domain features for clean speech; and
using the set of projected features for at least one of: a) generating synthesized speech that represents a noise-reduced version of the noisy speech, b) performing speaker recognition, or c) performing speech recognition.

2. The method of claim 1, wherein a first portion of the frequency domain features represents sound generated at the glottis, and a second a portion of the frequency domain features represents an impulse response of the vocal tract.

3. The method of claim 1, wherein the manifold corresponds to a combination of factor analysis models each representing a subspace of a feature space associated with the model of frequency domain features for clean speech.

4. The method of claim 1, wherein the manifold is learned using a corpus of clean speech samples.

5. The method of claim 1, wherein generating the synthesized speech comprises:
obtaining, from a first set of projected features a first spectra representing a first portion of the noise-reduced version of the noisy speech;
obtaining, from a second set of projected features, a second spectra representing a second portion of the noise-reduced version of the noisy speech; and
generating, by combining the first and second spectra, a time domain waveform of the noise-reduced version of the noisy speech.

6. The method of claim 5, wherein the first and second set of projected features are obtained by projecting corresponding sets of frequency domain features extracted from the input signal on to two separate portions of the manifold, respectively.

7. The method of claim 6, wherein each of the two separate portions of the manifold represents a locally linear subspace of a feature space associated with the model of frequency domain features for clean speech.

8. The method of claim 1, wherein the manifold also represents time derivatives of the one or more frequency domain features.

9. The method of claim 8, further comprising:
computing one or more time derivatives of at least a subset of the frequency domain features; and
concatenating the time derivatives to the one or more frequency domain features for generating the set of projected features.

10. The method of claim 1, wherein the frequency domain features of clean speech is modeled using a Hidden Markov Model (HMM) wherein each state of the HMM is represented by at least one factor analysis model.

11. A system comprising:
a feature extraction engine comprising one or more processing devices, the feature extraction engine configured to:
receive a portion of an input signal representing noisy speech, and
extract, from the portion of the input signal, one or more frequency domain features of the noisy speech; and
a projection engine comprising one or more processing devices, the projection engine configured to:
generate a set of projected features by projecting each of the one or more frequency domain features on a manifold that represents a model of frequency domain features for clean speech, and
provide the set of projected features for at least one of: a) generating synthesized speech that represents a noise-reduced version of the noisy speech, b) performing speaker recognition, or c) performing speech recognition.

12. The system of claim 11, wherein a first portion of the frequency domain features represents sound generated at the glottis, and a second portion of the frequency domain features represents an impulse response of the vocal tract.

13. The system of claim 11, wherein the manifold corresponds to a combination of factor analysis models each representing a subspace of a feature space associated with the model of frequency domain features for clean speech.

14. The system of claim 11, wherein the manifold is learned using a corpus of clean speech samples.

15. The system of claim 11, further comprising a speech synthesizer configured to:
obtain, from a first set of projected features, a first spectra representing a first portion of the noise-reduced version of the noisy speech;
obtain, from a second set of projected features, a second spectra representing a second portion of the noise-reduced version of the noisy speech; and
generate, by combining the first and second spectra, a time domain waveform of the noise-reduced version of the noisy speech.

16. The system of claim 15, wherein the projection engine is configured to obtain the first and second set of projected features by projecting corresponding sets of frequency domain features extracted from the input signal onto two separate portions of the manifold, respectively.

17. The system of claim 16, wherein each of the two separate portions of the manifold represents a locally linear subspace of a feature space associated with the model of frequency domain features for clean speech.

18. The system of claim 11, further comprising one of a speaker recognition engine or a speech recognition engine configured to use the set of projected features to perform speaker recognition or speech recognition, respectively.

19. The system of claim 11, wherein the frequency domain features of clean speech is modeled using a Hidden Markov Model (HMM) wherein each state of the HMM is represented by at least one factor analysis model.

20. One or more machine-readable storage devices having encoded thereon computer readable instructions for causing one or more processors to perform operations comprising:
receiving a portion of a noisy input signal;
extracting, from the portion of the input signal, one or more frequency domain features;
generating a set of projected features by projecting each of the one or more frequency domain features on a manifold that represents a model of frequency domain features for a corresponding clean signal; and
generating, based on the set of projected features, an output comprising a noise-reduced version of the noisy input signal.
